(19) United States
(12) Patent Application Publication
(10) Pub. No.: US 2013/0082529 A1
(43) Pub. Date: Apr. 4, 2013

(54) POWER GENERATION SYSTEM WITH INTEGRATED RENEWABLE ENERGY GENERATION, ENERGY STORAGE, AND POWER CONTROL

(71) Applicant: James Frederick Wolter, Spring Lake, MI (US)

(72) Inventor: James Frederick Wolter, Spring Lake, MI (US)

(21) Appl. No.: 13/628,941

(22) Filed: Sep. 27, 2012

Related U.S. Application Data
(60) Provisional application No. 61/540,848, filed on Sep. 29, 2011.

(51) Int. Cl. H02J 3/00

(52) U.S. Cl. CPC H02J 3/005
USPC 307/46

(57) ABSTRACT

A power generation system comprises a conventional motor-generator system as may be found in a stand-by power system with the addition of integrated renewable and stored energy assets. A software defined control system allows for optimizing total cost of power and allows user control or interconnection with micro-grid or Utility Power systems.

This application claims benefit under 35 U.S.C. section 119(e) of provisional application Ser. No. 61/540,848, filed Sep. 29, 2011, entitled POWER GENERATION SYSTEM WITH INTEGRATED RENEWABLE ENERGY GENERATION, ENERGY STORAGE, AND POWER CONTROL, the entire content of which is incorporated herein in its entirety.

### BACKGROUND OF THE INVENTION

The present invention relates to adding and controlling additional, integrated-Renewable and stored energy sources to conventional fossil-fueled electric generators (base-load, stationary, or portable auxiliary power systems) of any size. This augmentation includes generations systems whose output is electricity alone or in larger systems, may also be employed to integrate renewable energy sources with combined heat and power (CHP) systems where both electric and heat loads (heating and cooling) are desired.

This invention proposes the use of either renewable energy sources, such as solar power, wind power, biomass power, fuel cell power; and/or stored energy as may be provided by battery, flywheel, or super-capacitor sources; and/or Utility Grid power which singly or jointly in combination may be integrated with the fossil fueled generator to either offset fuel consumption or eliminate the need to consume fossil fuel where the renewable or stored energy sources on-hand are sufficient to power, or programmed to contribute to, the electric or thermal energy demand on-site. Additionally the system's programmable logic may be configured to integrate Utility Grid power to supplement or bypass the augmented generator completely when time-of-day rates make that a more economic choice. In the latter mode, low cost nighttime electricity could be stored to be returned to the grid during high cost, peak power cycles the next day creating an operating profit for the system's owner.

In conventional portable or stationary generator designs, a fossil fuel powered internal combustion engine is generally paired with a synchronous, wound field generator which must be precisely speed controlled to create the desired alternating current (AC Amperes for example), voltage (240/120 AC for example), and controlled frequency (50 HZ or 60 HZ for example). Such configurations are relatively fuel efficient (up to 70+% BTU-fuel input to electrical and heat conversion with premium generators) at higher loads but waste fuel when the applied electrical and thermal loads are small compared to the full output rating of the generator because the generator must continue to run at synchronous speed to maintain the required frequency (3600 RPM for a two-pole generator to create 60 HZ A.C. power for example). While such systems may use the internal combustion engines efficiently (up to 30% conversion of fossil fuel to rotational torque with 40% BTU extraction for heat loads) at full speed, they create unnecessary pollution, are noisy, and can waste over 90% of the fossil fuel to maintain synchronous speed when electric or thermal loads are light (nighttime for example).

Conventional stand-by generator systems sit idle most of the time because they are not turned on until there has been a power outage which in most Utility jurisdictions is a relatively infrequent occurrence. In contrast, with the present invention, renewable energy sources integrated into the system can actively generate electricity every day and this power can be used to power the load or be exported to the Utility through the built-in grid interconnection which can offset on-site power bills or support the external Utility in peak-load times. At an owner's discretion, this system could also be remotely dispatched by Utility Systems Operators to provide peaking offset power to the Utility during times of high grid stress. This feature when used in larger scale installations can make this invention an integral part of a smart-micro-grid and contribute to the economy and security of the local system and the Nation's power infrastructure.

A preferred method of integrating external renewable energy sources or energy storage devices with a fossil fueled generator is to use a permanent magnet alternator or an actively-rectified, variable speed, wound-field generator as the electric power source for the fossil fueled engine in combination with an electronic power inverter to provide constant frequency A.C. output. A first advantage of using a PM-alternator or actively rectified wound-field generator to power a D.C. to A.C. inverter as a power source is that it becomes unnecessary to speed control the fossil fuel engine to maintain the desired alternating current frequency (typically 50 HZ or 60 HZ) allowing the engine speed to run from relatively slow for low-loads to high speed for full-load requirements. A conventional wound-field, wound or shunted armature generator which is generally found in such power systems in common use must be run at constant speed to synchronize with the 50 HZ or 60 HZ designed system frequency output (for example a 2-pole generator must run at 3600 RPM to create a 60 HZ A.C. waveform). The use of permanent magnets in the rotor also eliminates the need to use slip-rings to transfer electrical excitation to the rotating armature-coils. Slip rings allow power control by adjusting the armature-voltage in a conventional alternator which is necessary to create the proportional magnetic field control needed to control the output power of the alternator. This present invention allows output power levels to be sensed by voltage control at the inverter's output allowing a feed-back loop to speed control the fossil fueled generator to precisely control fuel consumption for optimal efficiencies.

An advantage of using a PM-alternator and inverter combination is that the use of this combination to create the desired 60 HZ A.C. power can be up to 90% efficient in its electrical energy conversion and can enable the novel use of the inverter to generate A.C. power from the fossil-fueled generator in combination with multiple, paralleled D.C. electrical energy inputs to the inverter to create the needed power for the intended load. Any voltage-controlled D.C. input can be diode-isolated and paralleled as a controllable energy input to the output inverter. The novelty of the present invention lies in the range of operational (control) and design choices that the use of the same “internal inverter” with the fossil fueled generator and renewable or stored energy systems allows the designer and ultimately the user of the device. Choices range from using all fossil fuel (and zero renewable or stored energy) to using all renewable energy or stored energy (and zero fossil fuel) and any intermediate combination (percentage of fossil vs. renewable/stored energy) for operating and this function can be software controlled through a logic-control system. The inverter may be sized so that its power handling rating is equal to the full electrical power rating of the fossil generator or may be oversized to a much higher power rating than the IC-generator alone so that load-following to peaks higher than the IC-generator's designed-power capacity could be accomplished by drawing additional energy as needed from renewable or stored energy assets. The choice between these two sizing alternatives could be made based upon the constancy of the load requirement. If there is considerable variance between peak and average power needs then a larger (than the generator's peak power for example) inverter could be chosen and the load-following mechanism would be provided by the renewable energy, stored energy and/or the availability of Grid Power. The advantage of this configuration could allow the reduction in the size of the fossil fueled generator section by allowing the renewable energy or stored energy to handle the short term overloads. This would lead to a reduction of fuel consumption much in the same way a hybrid electric/gasoline automobile creates a net reduction in fuel consumption for drivers. This invention may run either in the electric power mode alone or in the CHP mode and enjoy the efficiency benefits of adding speed controlled fossil-fueled engines plus D.C. generators as the electric-generation technology of choice.

In one aspect of the present invention, the proposed system will result in an on-site power system that will provide daily power generated by the integrated renewable energy sources by using an integrated inverter to provide power output, without the necessity of running the fossil-fueled generator. Such a system has more utility than either an on-site renewable energy system or a back-up generator system by themselves because it provides all of the functions of both but may be managed by user-selected control algorithms to control cost or reliability of power as a user desires. The inverter section of this power system can be designed to meet all of the power quality and safety needed to be grid-intertied. This make this system have higher utility than stand-alone solar systems used in the grid intertie mode because the system described in this disclosure will function if there is a Utility power outage. Modern back-up power systems include an automatic transfer switch which allows the generator to operate during a power outage connected to the load (a residence for example) but disconnected from the Utility feed to meet “anti-islanding” regulations. This means that a lower cost “stand-alone” inverter design can be used which feeds power into the system in the absence of a grid signal because it is electrically upstream from and under the protection of the internal transfer switch and therefore will never energize a disabled Utility connection.

In another aspect of the present invention, the described system can be dispatched by so-called smart-grid management control (Systems Operators) so as to provide a net-export of peaking power to an overstressed local neighborhood micro-grid or a larger transmission and distribution system. A plurality of such systems strategically deployed in a geographical grid would provide crucial load shedding capability during a power emergency or high temperature day where Utility systems are caught in a net under-capacity situation. In this case, it is likely that the fossil fueled generator could also be used to provide external power and be economical in its use. For instance, in the long hot spells of summer, the cost per kilowatt-hour for peaking or imported power is often more expensive than the estimated 21 cent to 35 cent per kilowatt hour fuel costs or running an auxiliary, fossil fueled generator. The integration of renewable energy sources to these home-systems simply improves the economic benefit of their deployment in that they could easily be operated when time-of-day prices for power exceed the total operating costs of the collection of distributed, individually owned integrated power systems described in this application.

In another aspect of this invention the waste heat from the operation of the IC Generator may be captured and used for thermal energy control at the load (heating or cooling for example). Such combined heat and power (CHP) systems are well described in the literature. In common practice CHP systems demonstrate a thermal-equivalent efficiency of more than twice the rated electric power alone (as may be generated by the I/C. engine) and may represent an ideal economic or environmental application of this invention. For example where solar-thermal renewable energy systems are employed the described energy management system can become a central-hub for generating and controlling both electric and thermal energy on site. For example on a cold winter night the system could recharge batteries and heat the residence to optimize the fossil fuel efficiency of the system.

Conventional fossil fueled, portable or stationary generators presently rely exclusively upon fossil fuels to create electrical power for their intended loads. More particularly, such generators are costly to own and operate because their initial acquisition and installation costs, operating costs, and maintenance costs make their unit-cost of power (for instance the cost per kilowatt-hour of generated electricity) they produce multiples of the costs of buying power from a local Electrical Utility. For this reason so called home-backup-power systems are typically idle until there has been a power interruption whereupon they are called upon to provide either full or limited power to a home or business experiencing a power outage.

There are numerous other reasons why conventional electrical power generators are only used on a transient or emergency basis to provide on-site power in addition to their excessive costs;
1. they are typically not designed for continuous (base-load) duty
2. they are not economical sources of electrical power compared to average Utility rates
3. they create noxious pollution (noise and effluents)
4. they are inconvenient to refuel (requiring a just-in-time propane, or liquid fuel delivery)

The advantages of the present invention are; 1.) The additional energy inputs will seamlessly integrate with the fossil-fueled motor-generator's power output to reduce or even eliminate fuel consumption depending upon how the additional energy sources are sized and managed, 2.) During periods when the grid is active and no emergency power is required, this enhanced multiple energy-input power system will be active every day and can reduce or eliminate gird-supplied electricity demanded by the local load, 3.) The logic controls of the proposed system can make it an integrated part of a smart-grid management system wherein it can provide power when the local micro-grid needs additional power or store electrical energy when it is in surplus (at night for example) and return this stored energy when the need and economical advantage favors export of power from the described system. 4.) The proposed energy management system can become the hub for a sophisticated energy management system for discrete loads of any size allowing flexible deployment and logic controlled operation. This system can be configured to provide either A.C. or D.C. outputs given that many military operations are now experimenting with D.C. power appliances simplifying power requirements in permanent operational bases and forward operating base (F.O.B.) deployments.

### BRIEF SUMMARY OF THE INVENTION

In one aspect of the present invention a conventional back-up generator system is enhanced so as to provide an integrative function of adding to its output the power available in renewable energy or stored energy systems which are typically external to the generator housing. These external electrical sources may for example be a solar photovoltaic system, a fuel cell, small wind turbine, and/or a battery storage system. Since these energy sources are typically direct current, a “package inverter and control device” (118) can be mounted with the generator cabinet and used to feed A.C. to the distribution panel (116) in parallel with the generator's power output. [Ref. FIG. 1.]

In another aspect of the present invention a permanent magnet alternator or actively rectified wound-field generator (212) is directly driven by the internal combustion engine (210). The variable speed, variable frequency, typically three phase electric output of the alternator is rectified and used to feed the power switching transistors in a inverter (214) to create fixed-frequency (50 HZ or 60 HZ for example) alternating current having the power quality to be allowed in grid-parallel operation. This power inverter section may be sized to be equal to the maximum power output of the internal combustion engine or oversized to allow renewable energy or stored energy to be additively combined with the systems total output. [Ref. FIG. 2.]

In a preferred embodiment of this invention, the internal combustion engine (310) will directly drive a permanent magnet alternator or a wound-field, actively rectified generator (312) which will create a three-phase, varying frequency, alternating current electric power feed (314) to a bridge-rectifier (316) which in turn creates a rectified, non-filtered direct current link (318) to the software controlled power integration center (322). The actively rectified generator's output would be a phase controlled and rectified output as opposed to a multi-phase alternating current or the PM-alternator. This integration center receives and controls the external renewable or stored energy sources (332) under the smart-control center (338 and 338a). This control system integrates the generator's rectified power with renewable energy (332a-d) and stored energy sources (334, 334a, and 336) to seamlessly create a user controlled Eco-Gen™ power system. [Ref. FIG. 3.]

These and other aspects, objects, and features of the present invention will be understood and appreciated by those skilled in the arts of fossil-fueled engine design, permanent magnet or active-rectified generator designs, electronic power inversion, conditioning, and control of direct current and alternative current power-sources and software defined power management systems design. The following specifications, claims, and schematic drawings clarify the distinctive differences between the way portable and stationary generator systems are now constructed and operate, and the enhancements provided by embodiments of the proposed invention.

### DESCRIPTION OF THE APPENDED SCHEMATIC DRAWINGS

FIG. 1. Depicts an aspect of this invention using a conventional generator-set fueled by liquid, fossil, gaseous, or bio-fuels, using an internal combustion engine (110) to drive a synchronous-frequency controlled AC generator (112) which has the ability to add diverse energy (renewable and stored energy) resources using a software defined control algorithms and power switching elements (114). In many cases these alternative energy sources (118) will be direct current sources and will need to be converted to synchronous alternative current when paralleled with the generator's rectified output to supply the external load. Thus this embodiment requires a separate DC to AC inverter (118) to provide combined power to the systems output distribution panel. In this configuration the power sources are paralleled and combined on the system's inverter side of the automatic transfer switch which provides the required anti-islanding protection to meet common Utility interconnect requirements such as UL 1741 and IEEE 1547 permitting the integrated system to provide power to the load in the event of a grid power outage by the grid-isolating function of the transfer switch. This provision reduces the cost of the inverter by eliminating the anti-islanding circuitry and allows the inverter to operate in so-called off-grid mode continuously through the use of the standard transfer switch commonly provided with standby generator systems.

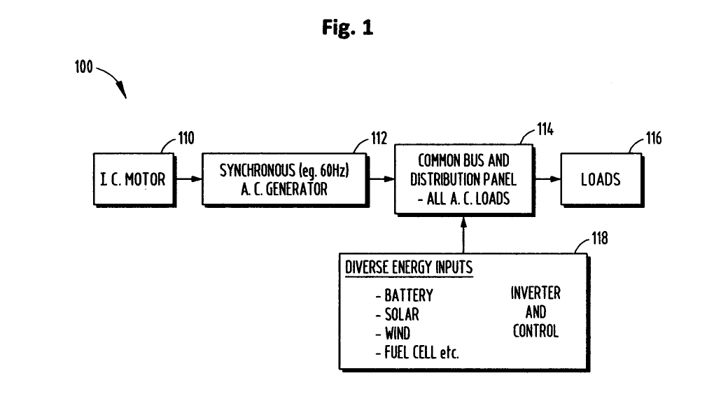

FIG. 2. Depicts an aspect of this invention which uses an I.C. motor-generator, heavy or light fueled (212), which drives a multi-phase, variable speed, variable frequency permanent magnet alternator or an actively rectified generator (212). The output of the alternator is fed into a multi-phase, bridge-rectified, power transistorized switching inverter (214) which is optimally transformerless for lighter weight and less cost. The inverter may be power-matched to equal the maximum rated power of the IC motor or oversized to allow the full power ratings of the system to significantly exceed the power rating of the fossil generator alone. This configuration has the advantage of eliminating the separate inverter used in FIG. 1 above. If this inverter is generously oversized its power handling capability can meet the maximum rated load specified by the power-system's full load rating by drawing from proximal renewable energy sources or stored energy devices (220). In actual practice, the I.C. motor-generator may be reduced in size in proportion to the power rating of the added alternative/renewable energy technologies to be deployed. The output of this master-inverter feeds the included transfer-switch and smart-distribution panel (216). This configuration will allow the alternative energy system (a solar panel installation for example) to be used on a daily basis to offset the need for utility supplied power without the need to run the I.C. motor generator. When the grid signal is missing the transfer switch disconnects the overall system from the grid and isolates the load to the back-up power system with all of its enhanced renewable energy and energy storage capabilities.

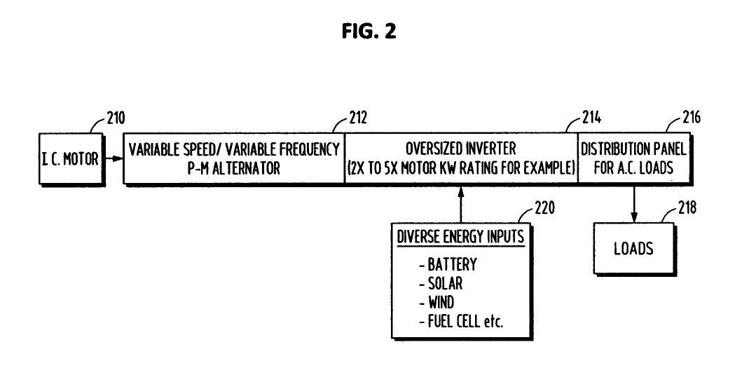

FIG. 3. depicts a schematic detail of FIG. 2. as a preferred embodiment of this invention which employs an internal combustion engine (310) directly driving a permanent magnet, three-phase alternator (312) using an electronic power inverter (324) as a local, fossil fueled powered AC-generation element. This system is integrated with renewable energy sources and an energy storage module through a controlled DC link (322) feeding the primary power inverter (324) in parallel with (or in exclusion of) the fossil fueled generator. The system uses an “always on” off-grid inverter but protects the grid interface by using the transfer switch (328) within the generator enclosure to isolate the inverter power from the grid-intertie during times of power outages. Both the renewable integration module (332) and or the battery management system (334) may require DC to DC conversion to provide matched voltages to the master inverter depending upon choices of renewable technologies and stored energy devices.

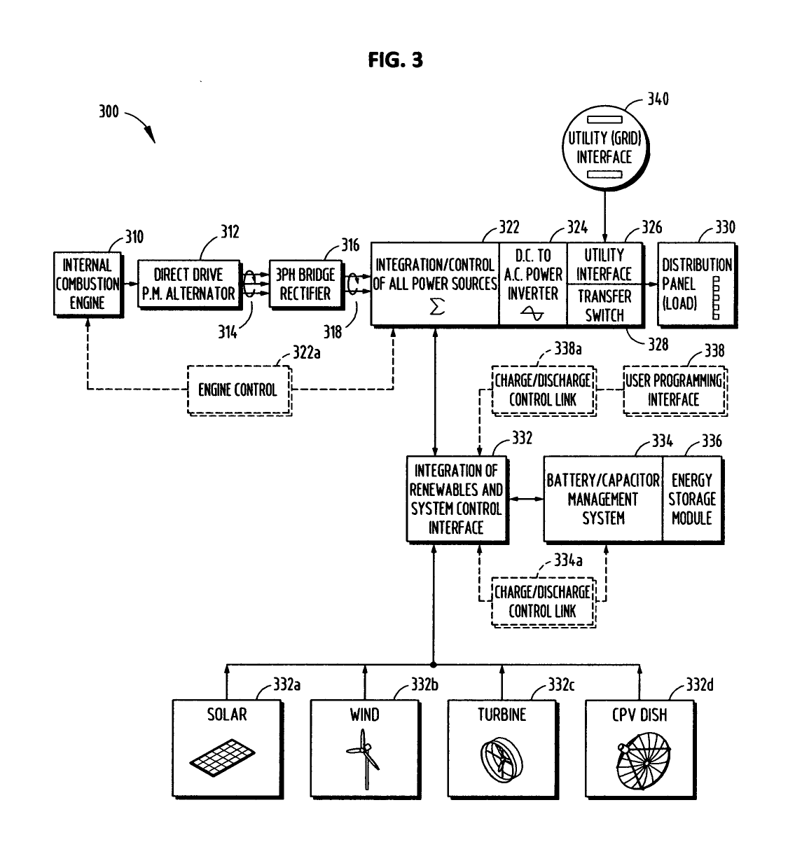

This system may be packaged in a single, weather-rated outdoor enclosure for the power producing and control elements keeping the fuel storage and the renewable energy systems remotely located and connected.

### DETAILED DESCRIPTION

The present electrical generating system may be employed to generate solely electrical power of be configured to supply both electrical and thermal energy. Such systems have been conventionally called Combined Heat and Power (CHP) systems and offer the advantage of the highest efficiency of use of fossil fuel sources where there is a balanced need for generating both electrical and thermal power from fossil fuel sources. It is understood that the thermal output of such systems may be employed for district heating or through the use of absorption cooling cycles also offer district cooling.

A common use of such fossil fueled electrical or CHP systems has been in so called standby power systems which remain idle until an interruption in Utility supplied power sources are interrupted. Such interruptions may be “acts of God” such as earthquakes, wind storms, or ice storms or may be caused by accidents or planned outages by Utility repair crews doing maintenance or upgrades on power systems. The novelty of the present invention is to transform the traditional generation station (large or small) into an energy integrating hub where the energy created by the fossil fuel generating device (a turbine or reciprocating engine-generator for examples) is seamlessly blended with the energy created by renewable energy sources or transferred from energy storage devices to be A.) additive power for the fossil generator, B.) combined power with the fossil generator to reduce the overall systems consumption rate of fossil fuel, or C.) fully substitute for the fossil fuel consumption needs of the system when the renewable sources or stored energy sources are sufficient to meet the load requirements placed on the system.

In fairly common circumstances fossil fuel generation sources of power are the primary source of electrical or thermal energy in numerous parts of the World. In many island nations and frequently in Third World locales, fossil fueled generators are used as prime power for a majority of the power needs on the island or the neighborhood. While it is becoming common for users of such power to add their own solar, wind generators, and back-up battery systems these are examples of “distributed generation” and not a modification to the centralized power plant as proposed here.

A first novelty of this invention is that millions of home-standby generator systems which may only function for a week or two every 6 years when a hurricane disables power service can become daily sources of power through the integration of home-installed renewable energy sources. Depending upon their design and sizing these renewable energy generation and storage devices may be fully capable of meeting the individual residence's daily power needs without running the included fossil generator device or without importing any grid supplied electricity.

A second novelty of this invention is that a plurality of these systems operating in neighborhood microgrids can readily relieve summertime stress on overtaxed Utility systems and help prevent brown-outs or rolling blackouts. As more and more coal fired power plants are sunsetted and in Nations where policy decisions dictate a planned retirement of nuclear power plants a network of such power systems can meet growing demands for sustainable energy sources. In one possible scenario, where Utility Companies promote and install such generation devices the control systems described in this system can allow Utilities to remotely dispatch large networks of these systems to avoid an unplanned but predicted power emergency situations.

A third novelty of this invention is that as smart-grid systems with their “time-of-day” pricing algorithms diffuse across a National scale the software-defined control system embedded in this system will activate the energy storage device designed into this system so it can be charged with relatively low-cost off-peak power sources and then return stored energy during peak-price times and essentially eliminate peak-demand over load pricing for the home or business owner. While this is an obvious advantage to the user customer it is also a substantial help (assuming large scale use of these systems) in balancing regional loading for multi-State Transmission and Distribution systems (so called “systems operators”).

A fourth novelty of this invention is that its widespread use will contribute to National Energy Security because it is an elegant answer to growing concerns about cyber attacks on an increasingly software-controlled energy generation and distribution systems or intentional damage to central power plants, oil or natural gas pipelines, and major trunks in the Nation's electrical T & D systems (the Grid).

A final novelty of this invention is its ability to reduce fuel consumption and personnel casualties in refueling operations for the military. It is estimated that in-theatre costs of refueling are in excess of $400 per gallon of fuel and adding the hostile engagements with fuel supply convoys and sniper attacks during scheduled refueling operations creates a situation which will embrace the proposed invention because it can be scaled from small (personal to large) in power capabilities.

The invention claimed is:

1. An electrical generating and power control system including an internal combustion (fossil fueled) motor-generator with a rectified D.C. output is parallel-fed to an inverter which may be also powered by renewable energy or stored energy sources to increase the total power of the system or to reduce or eliminate liquid or gaseous fossil or bio fuel sources for the motor-generator.

2. An fossil-fueled electrical generating device (employing a reciprocating, rotating, nutating or turbine-based motor) and power control system which employs a multi-phase, variable-frequency, varying-speed alternator or wound-field (actively rectified) generator, and an oversized inverter, which inverter may also be parallel fed with stored energy (batteries, supercapacitors, or flywheels for example) or active generating renewable energy assets (wind, solar, hydro, or fuel cell power sources) in concert with or to the exclusion of the internal combustion engine derived power. The inverter's power rating can be designed to meet the full load design of the system deriving its energy input from a combination of all energy resources at hand.

3. An “Smart” emergency power system that can provide A.C. and/or D.C. electrical power to loads in times when the grid is functioning normally or in the absence of grid-power or any fossil or bio-fuel availability using renewable energy sources and stored energy exclusively as available. This system has the software defined control system to support micro-grid or Utility-based remote control as contracted between the system's owner and the Utility.
